(19) United States
(12) Patent Application Publication
(10) Pub. No.: US 2019/0222890 A1
(43) Pub. Date: Jul. 18, 2019

(54) INTERACTIVE CONTENT MANAGEMENT

(71) Applicant: Outernets, Inc., New York, NY (US)

(72) Inventors: Omer GOLAN, Brooklyn, NY (US); Tal GOLAN, Brooklyn, NY (US)

(21) Appl. No.: 16/313,041

(22) PCT Filed: Jun. 23, 2017
(86) PCT No.: PCT/US17/39115

§ 371 Date: Dec. 23, 2018

Related U.S. Application Data
(60) Provisional application No. 62/354,092, filed on Jun. 23, 2016.

(51) Int. Cl. H04N 21/4402; H04N 21/433; H04N 21/45; H04N 21/472; H04N 21/4223

(52) U.S. Cl. CPC H04N 21/4402; H04N 21/433; A63F 13/2145; H04N 21/472; H04N 21/4223; H04N 21/45

(57) ABSTRACT

Systems and methods are disclosed for interactive content management. In one implementation, one or more inputs are received. The one or more inputs are processed to identify one or more content presentation surfaces. Based on an identification of the one or more content presentation surfaces, a first content item is modified. The first content item, as modified, is presented in relation to the one or more content presentation surfaces.

### CROSS-REFERENCE TO RELATED APPLICATIONS

This application is related to and claims the benefit of priority to U.S. Patent Application No. 62/354,092, filed Jun. 23, 2016, which is incorporated herein by reference in its entirety.

### TECHNICAL FIELD

Aspects and implementations of the present disclosure relate to data processing and, more specifically, but without limitation, to interactive content management.

### BACKGROUND

Most real-world structures and locations are only capable of providing static content. As a result, pedestrians are often not engaged with such content.

### SUMMARY

The following presents a shortened summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a compact form as a prelude to the more detailed description that is presented later.

In one aspect of the present disclosure, systems and methods are disclosed for interactive content management. In one implementation, one or more inputs are received. The one or more inputs are processed to identify one or more content presentation surfaces. Based on an identification of the one or more content presentation surfaces, a first content item is modified. The first content item, as modified, is presented in relation to the one or more content presentation surfaces.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system, in accordance with an example embodiment.

FIG. 2 illustrates an example device, in accordance with an example embodiment.

FIG. 3 illustrates an example scenario described herein, according to an example embodiment.

FIG. 4 illustrates an example scenario described herein, according to an example embodiment.

FIG. 5 illustrates an example scenario described herein, according to an example embodiment.

FIGS. 6A-6B illustrate example scenarios described herein, according to example embodiments.

FIGS. 7A-7B illustrate example scenarios described herein, according to example embodiments.

FIGS. 8A-8G illustrate example interfaces described herein, according to example embodiments.

FIGS. 9A-9B illustrate example scenarios described herein, according to example embodiments.

FIG. 10 is a flow chart illustrating a method, in accordance with an example embodiment, for interactive content management.

FIG. 11 is a block diagram illustrating components of a machine able to read instructions from a machine-readable medium and perform any of the methodologies discussed herein, according to an example embodiment.

### DETAILED DESCRIPTION

Aspects and implementations of the present disclosure are directed to interactive content management.

It can be appreciated that numerous ‘brick and mortar’ establishments (e.g., retail stores and other businesses) dedicate significant resources to designing the displays in their storefront windows. However, such efforts often fail to engage or attract customers, particularly during times that the business is closed. Accordingly, described herein are systems, methods, and related technologies for interactive content management. Using the described technologies, real-world structures, such as storefronts and other locations can be transformed into surfaces on which dynamic, interactive content can be projected/presented. In doing so, store owners, etc., can more effectively utilize their store windows and engage users, customers, etc., even when the store is closed.

As outlined in detail in the present disclosure, the described technologies are directed to and address specific technical challenges and longstanding deficiencies in multiple technical areas, including but not limited to content presentation, content delivery, and machine vision. As described in detail herein, the disclosed technologies provide specific, technical solutions to the referenced technical challenges and unmet needs in the referenced technical fields and provide numerous advantages and improvements upon conventional approaches. Additionally, in various implementations one or more of the hardware elements, components, etc., referenced herein operate to enable, improve, and/or enhance the described technologies, such as in a manner described herein.

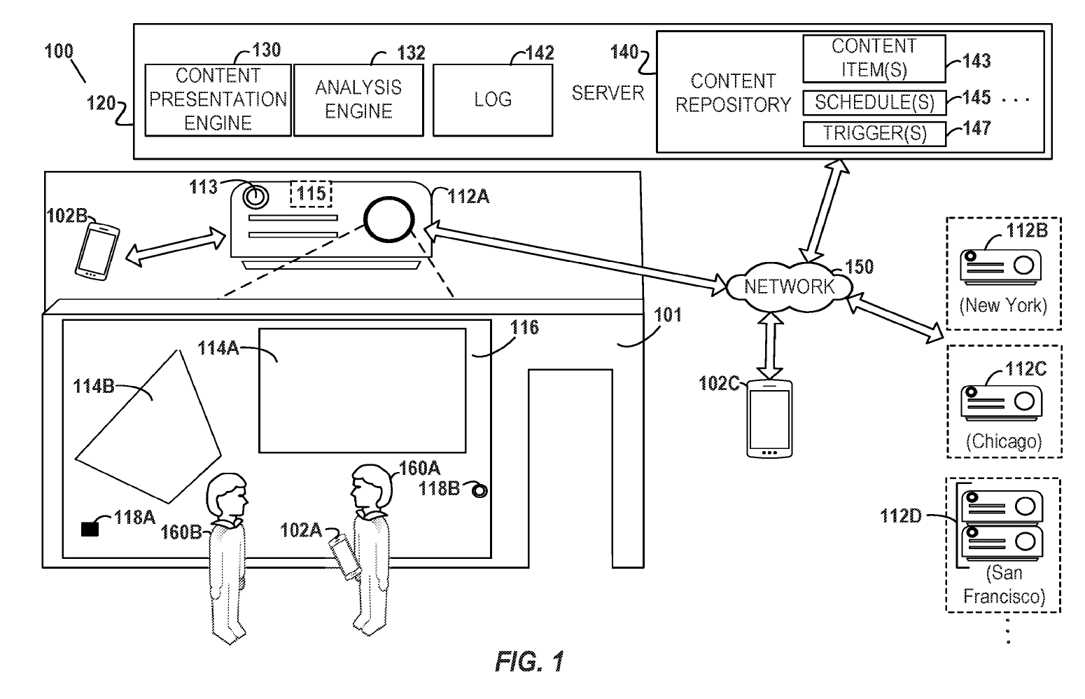

FIG. 1 illustrates an example system 100, in accordance with some implementations. As shown, system 100 includes one or more user devices (e.g., device 102A, device 102B, etc., collectively user device(s) 102), content presentation devices (e.g., content presentation device 112A, content presentation device 112B, etc., collectively content presentation device(s) 112), and server 120. These (and other) elements or components can be connected to one another via network 150, which can be a public network (e.g., the Internet), a private network (e.g., a local area network (LAN) or wide area network (WAN)), or a combination thereof.

Additionally, in certain implementations various elements may communicate and/or otherwise interface with one another (e.g., user device 102B with content presentation device 112A, as shown in FIG. 1).

System 100 can include one or more content presentation device(s) 112. Examples of such content presentation devices 112 include but are not limited to projectors or smart projectors 112. In certain implementations, such projector(s) can be, for example, a 10K-15K ANSI lumens high-definition video laser projector. Such a projector can be further equipped with a lens such as an ultra-short throw lens (e.g., to project content on an area measuring 100 inches diagonal from a projector positioned two to three feet away from the projection surface). Such a projector may thus be capable of projecting high contrast, color-rich images, such as those that may be easily visible when projected on glass (e.g., a window having a rear projection film applied to it), as described herein.

In certain implementations, content presentation device 112 can further include components such as a processor, controller, memory, etc., such as are present in other computing devices described in detail herein. Additionally, content presentation device 112 can also incorporate or include various sensor(s) such as an imaging sensor 113 (e.g., a camera). As described in detail herein, such a sensor can enable content presentation device 112 to, for example, detect/identify a content presentation surface (e.g., reflective film) in order to map content being presented to such surface.

Additionally, in certain implementations content presentation device 112 can include/incorporate various communication interface(s) (e.g., network interfaces such as Wifi, Ethernet, etc., as are described herein). Such components enable the content presentation device 112 to transmit/receive data, content, information, etc., from other systems, devices, etc., as described herein. Moreover, in certain implementations content presentation device 112 can include an application, module, operating system, etc., such as content presentation application 115. Application 115 can, for example, execute on content presentation device 112 to configure/enable the device 112 to perform the various operations described herein.

In certain implementations, content presentation device 112 can also include and/or otherwise incorporate various additional components. For example, content presentation device 112 can further include a proximity sensor, a light sensor (e.g., for ambient light detection, thereby enabling automatic adjustment of the projector's brightness), a camera (e.g., for color detection/adjustment, facial and gesture tracking, etc., as described herein), a local and/or remote computing device (such as are described herein, e.g., with respect to server 120), which is capable of running multiple applications, and includes internal WIFI/GSM components and sensor(s) (e.g., GPS, NFC, accelerometer (e.g., for tilt and angle detection), etc.).

In certain implementations, the described technologies can combine and/or otherwise integrate content presentation device's 112 (e.g., a projector's) key stoning capability, e.g., to calibrate and align the projector's output to the camera view and automate various projection mapping and masking operations/functions. For example, an accelerometer embedded within/connected to content presentation device 112 can be used to determine the angle at which the projector is positioned, and can adjust the image being projected accordingly, in order to ensure that the content is properly viewable on the film/window.

As shown in FIG. 1, in certain implementations content presentation device 112 can project content (e.g., images, text, etc.), towards a content presentation surface 114. Such a content presentation surface can, for example, be a film (or other such surface) which can be affixed or applied to a window or other such structure. In various implementations, such a film can be opaque, translucent, capable of adjustment between opaque and translucent, colored (e.g., black, dark gray, gray, white, mirror, polymer-dispersed liquid crystals (PDLC), etc.).

In certain implementations, content presentation surfaces 114 can be constructed in various shapes. For example, as shown in FIG. 1, window 116 of structure 101 (e.g., a building) has projection films 114A and 114B applied to it, each of which is cut into a different shape. In certain implementations, the content being projected (e.g., by content presentation device 112) is depicted on the shape (but otherwise not visible on the surrounding area of window 116).

Additionally, in certain implementations one or more sensors (e.g., an integrated imaging sensor 113, e.g., a camera) can be configured to detect the shape of the film. Based on such detected shape (e.g., a rectangle in the case of film 114A as shown in FIG. 1) the referenced content can be adjusted, modified, etc. accordingly, (e.g., to ensure that the center of the projected content is visible on the film).

By way of illustration, as shown in FIG. 1, content presentation device 112A (e.g., a projector) can be positioned within building 101. Using sensor/camera 113, content presentation device 112A can identify/detect content presentation surfaces 114A and 114B (e.g., as affixed to window 116). Content presented by content presentation device 112A (e.g., projected towards such content presentation surfaces) can be adjusted, modified, etc., e.g., in light of the shape of the surface(s), the type/material or properties of the surface(s), aspects of the content to be presented, etc.

Moreover, as shown in FIG. 1, various sensors, devices, etc., can be embedded or otherwise integrated within the referenced film 114, attached to the referenced window 116, and/or otherwise positioned in proximity thereto. Examples of such device(s) include sensor 118A which can be an NFC chip/sensor which can be configured, for example, to collect data, provide data, connect to the end user (e.g., people passing by the window), etc. By way of further example, sensor 118B can be an image sensor (e.g., a camera) configured to capture images, video, and/or other such visual content perceived opposite/in front of window 116. Various other sensors (e.g., a microphone), as well as further output devices (e.g., speakers) can also be arranged in a similar manner. In doing so, the referenced devices/techniques can be employed to control the content and enable interaction with it, as described herein.

It should be understood that while FIG. 1 (and various other examples provided herein) depicts/describes the described technologies (including content presentation devices 112) with respect to projectors, the described technologies are not so limited. Accordingly, it should be understood that, in other implementations, the described technologies can be configured and/or otherwise applied with respect to practically any type of content presentation device. For example, various aspects of the described technologies can also be implemented with respect to display devices including but not limited to video walls, LCD/LED screens, etc.

Additionally, in certain implementations the referenced content presentation surfaces 114 can be further embedded with various sensors, etc., such as those that are capable of perceiving touch and/or other interactions (e.g., ‘touch foil’). In doing so, user interactions with surface 114 can be perceived and processed, and further aspects of the content being depicted (as well as other functionality) can be adjusted/controlled as a result, e.g., in a manner described herein.

It should be noted that, as shown in FIG. 1, multiple content presentation devices 112 (e.g., device 112B, 112C, etc.) can be deployed across different geographic areas (e.g., in the case of a national retail chain). In doing so, the described technologies can enable such content presentation devices to be managed in a centralized manner. In doing so, for example, content determined to be effective in one location can be transmitted/utilized in another location. Moreover, it should be noted that in certain scenarios multiple content presentation devices can be combined together at a single installation (e.g., an array of devices, such as show in FIG. 1 with respect to 112D).

As noted above and further described herein, various aspects and/or elements of the content presentation device 112, sensors that are coupled connected thereto, etc., can be connected to (directly and/or indirectly) and/or otherwise engage in communication with various devices. One example of such a device is user device 102.

User device 102 can be a rackmount server, a router computer, a personal computer, a portable digital assistant, a laptop computer, a tablet computer, a camera, a video camera, a netbook, a media center, a smartphone, a wearable device, a virtual reality device, an augmented reality device, any combination of the above, or any other such computing device capable of implementing the various features described herein. Various applications, such as mobile applications (‘apps’), web browsers, etc. may run on the user device (e.g., on the operating system of the user device).

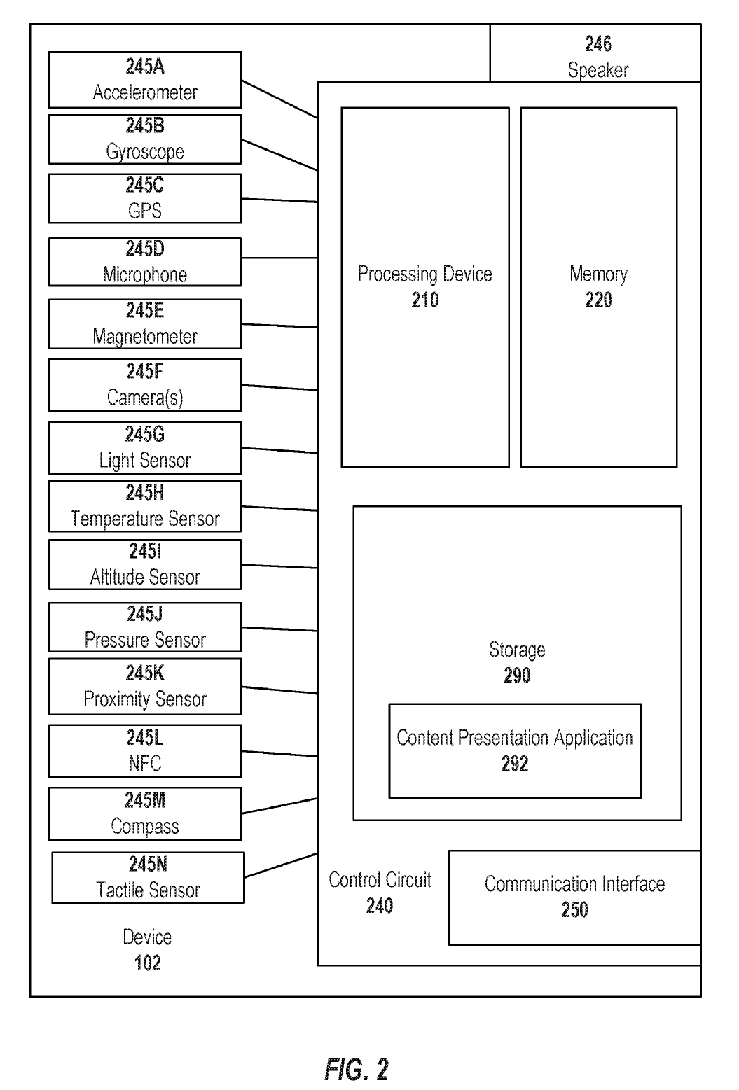

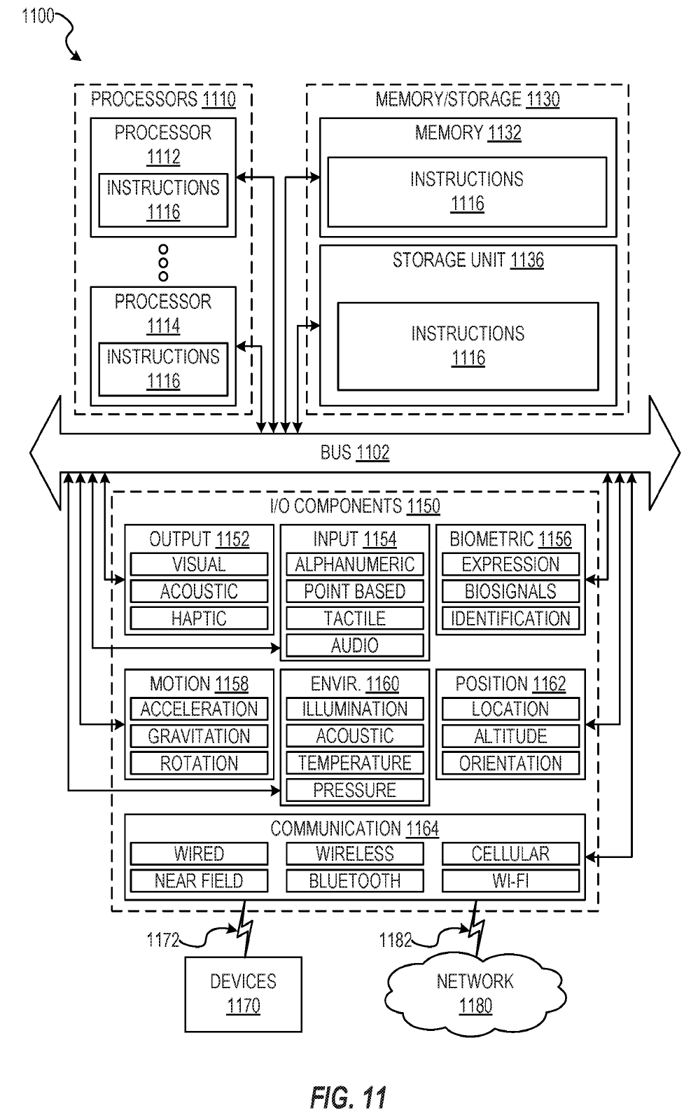

In certain implementations, user device 102 can also include and/or incorporate various sensors and/or communications interfaces (including but not limited to those depicted in FIGS. 2 and 11 and/or described/referenced herein). Examples of such sensors include but are not limited to: accelerometer, gyroscope, compass, GPS, haptic sensors (e.g., touchscreen, buttons, etc.), microphone, camera, etc. Examples of such communication interfaces include but are not limited to cellular (e.g., 3G, 4G, etc.) interface(s), Bluetooth interface, WiFi interface, USB interface, NFC interface, etc.

As noted, in certain implementations, user device(s) 102 can also include and/or incorporate various sensors and/or communications interfaces. By way of illustration, FIG. 2 depicts one example illustration of user device 102. As shown in FIG. 2, device 102 can include a control circuit 240 (e.g., a motherboard) which is operatively connected to various hardware and/or software components that serve to enable various operations, such as those described herein. Control circuit 240 can be operatively connected to processing device 210 and memory 220. Processing device 210 serves to execute instructions for software that can be loaded into memory 220. Processing device 210 can be a number of processors, a multi-processor core, or some other type of processor, depending on the particular implementation. Further, processor 210 can be implemented using a number of heterogeneous processor systems in which a main processor is present with secondary processors on a single chip. As another illustrative example, processing device 210 can be a symmetric multi-processor system containing multiple processors of the same type.

Memory 220 and/or storage 290 may be accessible by processor 210, thereby enabling processing device 210 to receive and execute instructions stored on memory 220 and/or on storage 290. Memory 220 can be, for example, a random access memory (RAM) or any other suitable volatile or non-volatile computer readable storage medium. In addition, memory 220 can be fixed or removable. Storage 290 can take various forms, depending on the particular implementation. For example, storage 290 can contain one or more components or devices. For example, storage 290 can be a hard drive, a flash memory, a rewritable optical disk, a rewritable magnetic tape, or some combination of the above. Storage 290 also can be fixed or removable.

As shown in FIG. 2, storage 290 can store content presentation application 292. In certain implementations, content presentation application 292 can be, for example, instructions, an ‘app,’ etc., that can be loaded into memory 220 and/or executed by processing device 210, in order to enable a user of the device to interact with and/or otherwise utilize the technologies described herein (e.g., in conjunction with/communication with server 120).

In certain implementations, content presentation application 292 can enable a user (e.g., a content administrator) to manage, configure, etc., various aspects of the operation of content presentation device(s) 112. For example, application 292 can enable the user to select content to be presented at a particular content presentation device at a particular time, under particular conditions, etc. In other implementations, application 292 can enable user to interact with content presented by a content presentation device 112 (e.g., to control a video game presented by content presentation device(s) 112, as described herein. In yet other implementations, application 292 can provide various interface(s) that enable a user (e.g., a content administrator) to review various analytics, metrics, etc., with respect to the performance of content presentation device(s) 112, e.g., as described in detail below.

A communication interface 250 is also operatively connected to control circuit 240. Communication interface 250 can be any interface (or multiple interfaces) that enables communication between user device 102 and one or more external devices, machines, services, systems, and/or elements (including but not limited to those depicted in FIG. 1 and described herein). Communication interface 250 can include (but is not limited to) a modem, a Network Interface Card (NIC), an integrated network interface, a radio frequency transmitter/receiver (e.g., WiFi, Bluetooth, cellular, NFC), a satellite communication transmitter/receiver, an infrared port, a USB connection, or any other such interfaces for connecting device 102 to other computing devices, systems, services, and/or communication networks such as the Internet. Such connections can include a wired connection or a wireless connection (e.g. 802.11) though it should be understood that communication interface 250 can be practically any interface that enables communication to/from the control circuit 240 and/or the various components described herein.

At various points during the operation of described technologies, device 102 can communicate with one or more other devices, systems, services, servers, etc., such as those depicted in FIG. 1 and/or described herein. Such devices, systems, services, servers, etc., can transmit and/or receive data to/from the user device 102, thereby enhancing the operation of the described technologies, such as is described in detail herein. It should be understood that the referenced devices, systems, services, servers, etc., can be in direct communication with user device 102, indirect communication with user device 102, constant/ongoing communication with user device 102, periodic communication with user device 102, and/or can be communicatively coordinated with user device 102, as described herein.

Also connected to and/or in communication with control circuit 240 of user device 102 are one or more sensors 245A-245N (collectively, sensors 245). Sensors 245 can be various components, devices, and/or receivers that can be incorporated/integrated within and/or in communication with user device 102. Sensors 245 can be configured to detect one or more stimuli, phenomena, or any other such inputs, described herein. Examples of such sensors 245 include, but are not limited to: accelerometer 245A, gyroscope 245B, GPS receiver 245C, microphone 245D, magnetometer 245E, camera 245F, light sensor 245G, temperature sensor 245H, altitude sensor 2451, pressure sensor 2451, proximity sensor 245K, near-field communication (NFC) device 245L, compass 245M, and tactile sensor 245N. As described herein, device 102 can perceive/receive various inputs from sensors 245 and such inputs can be used to initiate, enable, and/or enhance various operations and/or aspects thereof, such as is described herein.

At this juncture it should be noted that while the foregoing description (e.g., with respect to sensors 245) has been directed to user device 102, various other devices, systems, servers, services, etc. (such as are depicted in FIG. 1 and/or described herein) can similarly incorporate the components, elements, and/or capabilities described with respect to user device 102. It should also be understood that certain aspects and implementations of various devices, systems, servers, services, etc., such as those depicted in FIG. 1 and/or described herein, are also described in greater detail below in relation to FIG. 11.

Server 120 can be a rackmount server, a router computer, a personal computer, a portable digital assistant, a mobile phone, a laptop computer, a tablet computer, a camera, a video camera, a netbook, a desktop computer, a smartphone, a media center, a smartwatch, an in-vehicle computer/system, any combination of the above, a storage service (e.g., a ‘cloud’ service), or any other such computing device capable of implementing the various features described herein.

Server 120 can include components such as content presentation engine 130, analysis engine 132, content repository 140, and log 142. It should be understood that, in certain implementations, server 120 can also include and/or incorporate various sensors and/or communications interfaces (including but not limited to those depicted in FIG. 2 and described in relation to user device 102). The components can be combined together or separated in further components, according to a particular implementation. It should be noted that in some implementations, various components of server machine 120 may run on separate machines (for example, content repository 140 can be a separate device). Moreover, some operations of certain of the components are described in more detail below.

Content presentation engine 130 can be an application, program, module, etc., such as may be stored in memory of a device/server and executed by one or more processor(s) of the device/server. In doing so, server 120 can be configured to perform various operations, provide/present content to content presentation device 112, etc., and perform various other operations described herein.

Analysis engine 132 can be an application, program, etc., that processes information from log 142 and/or other sources, e.g., in order to compute and provide various analytics, metrics, reports, etc., pertaining to the described technologies, as described in detail below. Log 142 can be a database or other such set of records that reflects various aspects of the operation of the described technologies (e.g., what content what shown at a certain location at a particular time). In certain implementations, log 142 can further reflect or include information collected/obtained via various sensors. For example, log 142 can reflect the manner in which various users react/respond to different types of content, as described herein.

Content repository 140 can be hosted by one or more storage devices, such as main memory, magnetic or optical storage based disks, tapes or hard drives, NAS, SAN, and so forth. In some implementations, repository 140 can be a network-attached file server, while in other implementations repository 140 can be some other type of persistent storage such as an object-oriented database, a relational database, and so forth, that may be hosted by server 120 or one or more different machines coupled to server 120 via network 150, while in yet other implementations repository 140 may be a database that is hosted by another entity and made accessible to server 120.

Content repository 140 can store content item(s) 143, schedule(s) 145, trigger(s) 147, and various other information, data, etc., described/referenced herein. Content items 143 can include but are not limited to images, text, video, timed images, social media content, interactive experiences, cinemagraphs, games, and any other digital media or content that can be presented/provided, e.g., via the technologies described herein. Schedule(s) 145 can include or reflect a chronological sequence or framework that dictates the manner in which various content items are to be presented/projected. In certain implementations, such schedule(s) can be continuous, such that the included/referenced content continues to repeat in accordance with the schedule. Trigger(s) 147 can include or reflect various phenomena, stimuli, etc., that, when perceived, observed, etc., can cause various operations to be initiated. In certain implementations, such trigger(s) can be associated with various content item(s), such that the associated content items are to be presented in response to the trigger. Such triggers can correspond to any number of phenomena, such as human behaviors (e.g., present certain content when a user is determined to be smiling), natural occurrences (e.g., presenter certain content when it is raining outside), etc. Accordingly, schedule(s) 145 and trigger(s) 147 can define a framework within which content presentation device(s) 112 are to present/project content items 143 (e.g., onto surface(s) 114).

At this juncture it should be noted that various applications can be employed with respect to the described content presentation technologies. In certain implementations, such applications can enable content to be presented in a dynamic manner. For example, specific content can be presented/projected by content presentation device 112 based on interaction(s) initiated by various users (e.g., users standing in front of or passing by window 116). Additionally, in certain implementations various further actions or operations can be initiated in response to such interactions (e.g., initiating a social media posting, ecommerce purchase, etc., based on a user's interaction with content presentation device 112).

Examples of such applications include but are not limited to applications that configure the described technologies to enable discovery, purchase and/or installation of apps (e.g., from an app marketplace), galleries, slideshows, drop file, video playlist, ecommerce, live video (e.g., broadcasting video captured via a device, e.g., a smartphone, on the window via the projector), games, designs, and/art (such as many be sold/accessed via a content marketplace), etc.

By way of illustration, content presentation device 112 can be configured to project/present a ‘window shopping’ application. Such an application can enable dynamic/interactive presentation of a retailer's product catalog via the described content presentation technologies (e.g., projected on surface(s) 114). A user can interact with, browse, etc. such content. Upon identifying a desired item, the user can initiate/execute the purchase via the user's smartphone 102 (even when, for example, the retail location is closed). Such a transaction can be completed, for example, e.g., by projecting/presenting a QR code (via the described technologies) that can be recognized by the user's device (through which the transaction can be executed/completed, e.g., via an ecommerce application or webpage).

It should be understood that though FIG. 1 depicts server 120, content presentation device 112, and various user device(s) 102 as being discrete components, in various implementations any number of such components (and/or elements/functions thereof) can be combined, such as within a single component/system. For example, in certain implementations device 102 can incorporate features of server 120.

As described in detail herein, various technologies are disclosed that enable interactive/dynamic content presentation and management. In certain implementations, such technologies can encompass operations performed by and/or in conjunction with content presentation device 112, server 120, device(s) 102, and various other devices and components, such as are referenced herein.

As used herein, the term “configured” encompasses its plain and ordinary meaning. In one example, a machine is configured to carry out a method by having software code for that method stored in a memory that is accessible to the processor(s) of the machine. The processor(s) access the memory to implement the method. In another example, the instructions for carrying out the method are hard-wired into the processor(s). In yet another example, a portion of the instructions are hard-wired, and a portion of the instructions are stored as software code in the memory.

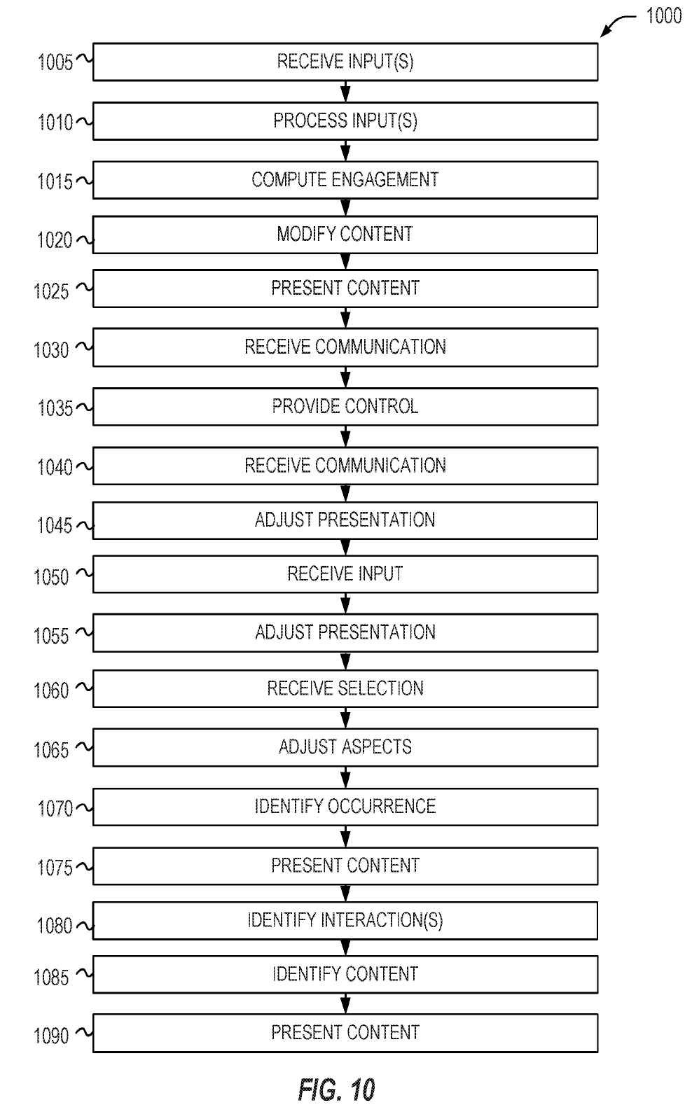

FIG. 10 is a flow chart illustrating a method 1000, according to an example embodiment, for interactive content management. The method is performed by processing logic that can comprise hardware (circuitry, dedicated logic, etc.), software (such as is run on a computing device such as those described herein), or a combination of both. In one implementation, the method 1000 is performed by one or more elements depicted and/or described in relation to FIG. 1 (including but not limited to content presentation device 112, content presentation engine 130, analysis engine 132, server 120, and/or user device(s) 102) and/or FIG. 2 (e.g., application 292 and/or device 102), while in some other implementations, the one or more blocks of FIG. 10 can be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At operation 1005, one or more inputs are received. Such inputs can be received from various sensors, such as sensor 113 as shown in FIG. 1 and described herein. In certain implementations, such inputs can include one or more images, as described herein. Moreover, in certain implementations the referenced one or more inputs can corresponding to a position of a content presentation device (e.g., in relation to the one or more content presentation surfaces).

By way of illustration, as noted above, the described technologies can be utilized to control various aspects of the functionality of content presentation device 112. For example, the output of a projector (e.g., the image) can be calibrated. In doing so, the content being projected can be aligned with the projector's camera view, e.g., to automate the projection mapping and content presentation capabilities.

At operation 1010, one or more inputs are processed. In doing so, one or more content presentation surfaces are identified, e.g., as described herein. In certain implementations, the one or more inputs can be processed to identify at least one location, position, and/or shape of the one or more content presentation surfaces (e.g., the described reflective film, such as surface 114A as shown in FIG. 1 and described herein).

At operation 1015, an engagement metric is computed. For example, as described herein, a level or degree of engagement of a user can be determined. For example, a user standing (e.g., not moving) in front of a window and facing/looking towards it can be determined to be likely to be engaged by the content being presented on the window, while a user walking by a window (and not looking at it) can be determined to be relatively unlikely to be engaged by the content being displayed. Accordingly, in certain implementations the described technologies can be configured to determine such a degree of engagement of one or more users (e.g., using facial recognition, etc.). Additionally, the content being depicted can be selected/modified accordingly. For example, upon determining that a particular user is not engaged in the content being presented (e.g., is walking by a window), content that is configured to get the user's attention (e.g., with bright lights, colors, promotional information, etc.) can be projected/presented, in order to get the viewer's attention and encourage them to further engage with the displayed content.

At operation 1020, a first content item is modified. In certain implementations, such content can be modified based on an identification of the one or more content presentation surfaces (e.g., at operation 1010). Moreover, in certain implementations the first content item can be modified based on an engagement metric (e.g., as computed at operation 1015).

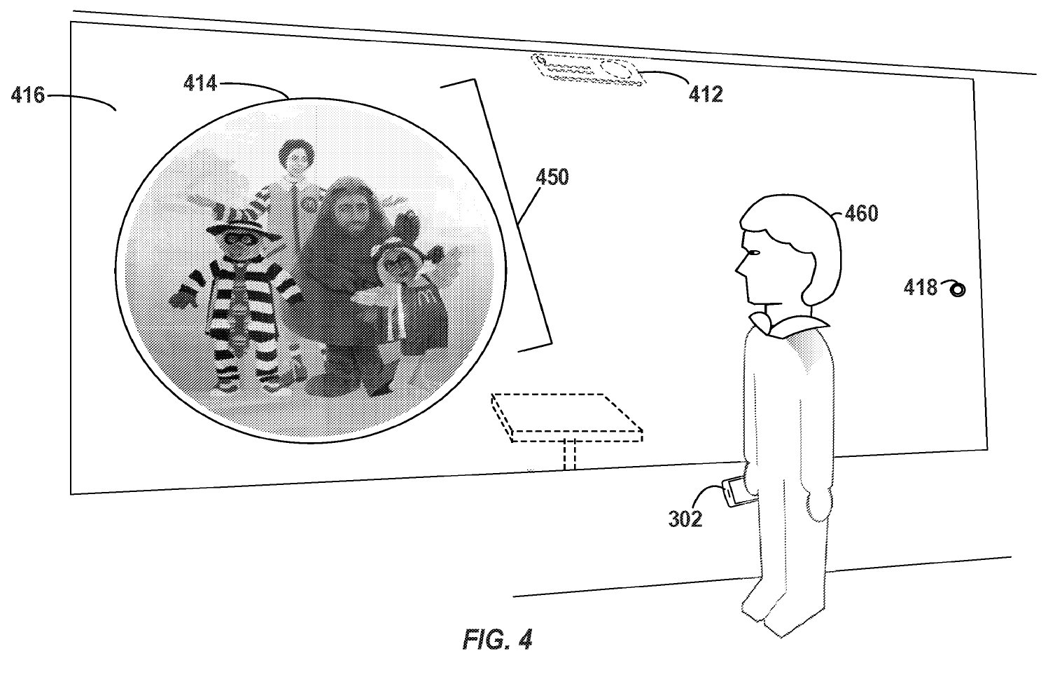

In certain implementations, one or more aspects of the one or more inputs can be incorporated into the first content item. Further aspects of this functionality are illustrated herein in relation to FIG. 4 in which images/videos of the ‘bodies’ of the depicted characters can be retrieved (e.g., from content repository 140) and modified to incorporate characteristics (here, faces) of various users (e.g., user 460) that may be standing in front of window 416 (which may be captured by embedded and/or connected cameras, e.g., camera 418 as shown).

At operation 1025, the first content item, as modified, is presented, projected, etc., e.g., in relation to the one or more content presentation surfaces (e.g., those identified at operation 1010), such as in a manner described herein.

In certain implementations, the first content item can be associated with one or more content presentation triggers. In such scenarios, the first content item can be presented in response to a determination that at least one of the one or more content presentation triggers has occurred.

By way of illustration, in certain implementations the described technologies can enable various trigger(s) 147 to be associated with different content item(s) 143. Examples of such triggers include but are not limited to various phenomena perceived by one or more integrated/connected sensors (e.g., camera, NFC, etc.). Such phenomena can reflect, for example, various user actions/interactions (e.g., gesture interactions, facial recognition, mood recognition, etc.), various contextual information (e.g., current time, date, season, weather, etc.), content originating from third-party sources (e.g., news items, social media postings, etc.), etc. By way of illustration, upon detecting/perceiving that a user is performing a particular gesture, expressing a particular mood, etc., content corresponding to such a ‘trigger’ can be selected and presented to the user. By way of further example, one or more of the referenced triggers (e.g., a determination that one or more users are viewing or standing in front of a window) can be utilized to initiate the presentation of content.

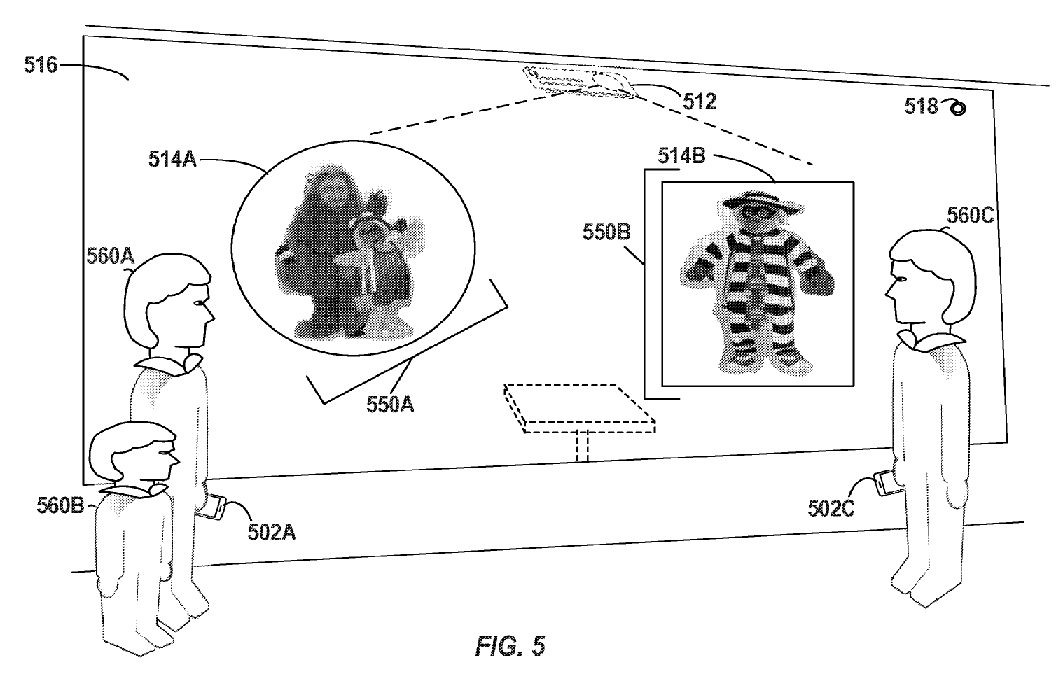

In certain implementations, a first content item can be presented in relation to a first content presentation surface and a second content item in relation to a second content presentation surface. One example scenario of this functionality is depicted/described herein in relation to FIG. 5 (in which various content items 550A, 550B can be presented on respective content presentation surfaces).

Moreover, in certain implementations presenting the first content item can be presented based on a content presentation schedule. As described herein, such schedule(s) 145 can include or reflect a chronological sequence or framework that dictates the manner in which various content items are to be presented/projected. In certain implementations, such schedule(s) can be continuous, such that the included/referenced content continues to repeat in accordance with the schedule.

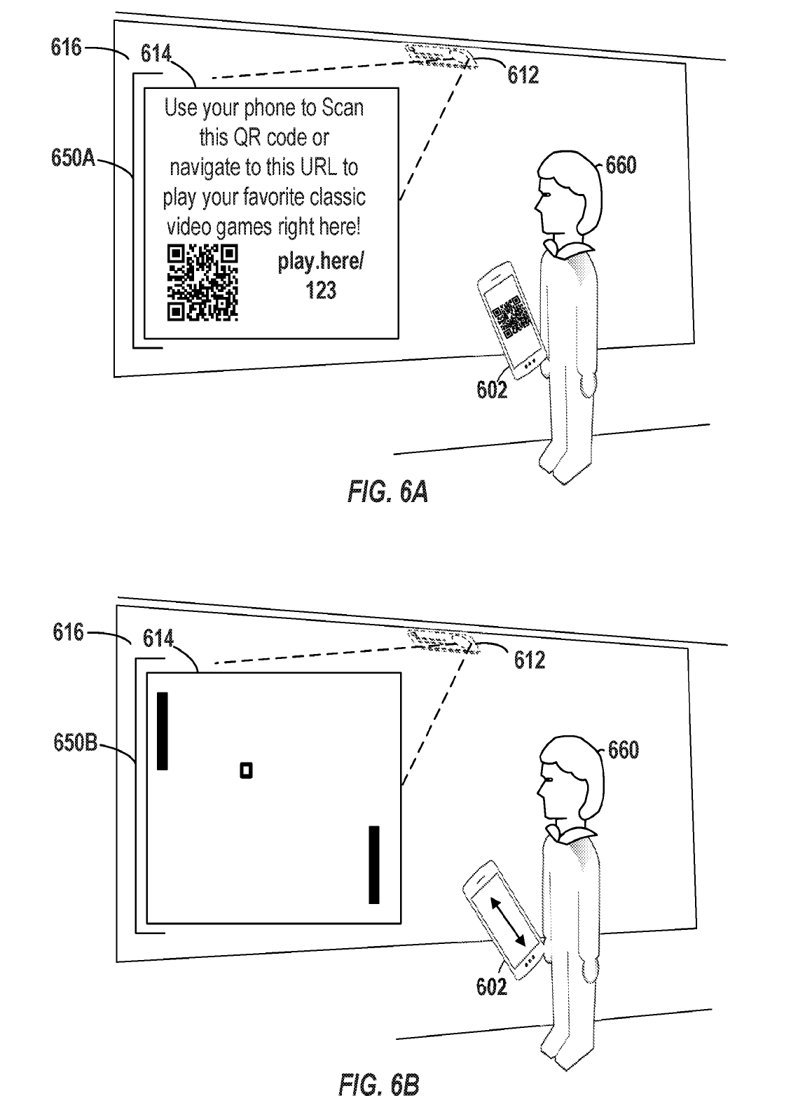

At operation 1030, a first communication associated with the first content item is received, e.g. from a user device. Once example scenario of such a communication is depicted/described herein in relation to FIG. 6A.

At operation 1035, a content control is provided to the user device, e.g., in response to the first communication (e.g., the communication received at operation 1030). Such a content control can be, for example, an application, interface, etc., through which the user can control content being presented. Once example scenario pertaining to such a control is depicted/described herein in relation to FIG. 6B.

At operation 1040, a second communication provided by the user device via the content control is received, such as in a manner described herein

At operation 1045, a presentation of the first content item is adjusted, e.g., in response to the second communication (e.g., the communication received at operation 1040).

At operation 1050, an input corresponding to presentation of the first content item is received, such as in a manner described herein.

At operation 1055, a presentation of a second content item is adjusted, e.g., based on the input received at operation 1050.

At operation 1060, a selection of the first content item is received, such as in a manner described herein.

At operation 1065, one or more aspects of the one or more content presentation surfaces are adjusted based on the selection of the first content item (e.g., at operation 1060).

By way of illustration, in certain implementations the described technologies can generate suggestions regarding the size/shape of content presentation surfaces 114 (e.g., the referenced film(s) affixed to window 116. For example, upon receiving a selection of various content items/a content presentation, the selected content can be processed/analyzed to identify various visual parameters (e.g., size, shape, etc.) of the content and/or to determine various ways of presenting the content, e.g., to enhance visibility of some/all of the content. Based on such determinations, various suggestions can be generated and/or provided, e.g., with respect to the shape, size, and/or relative location of content presentation surfaces 114 (e.g., the referenced film(s)) on which the content is to be projected/presented.

Moreover, in certain implementations the described technologies can provide an application, interface, etc., through which the referenced content (e.g., images, video, text, etc.) can be created, customized, defined, adjusted, etc. For example, a graphical user interface (such as may be accessible via a user device such as a smartphone, tablet, PC, etc.) can enable a user to select content (e.g., images, video, applications, content retrieved from other sources, e.g., social media postings, etc.), modify or adjust it in various ways (e.g., define the shape of the content, define the relative location within a window that the content is to be presented, insert text or other content, insert transitions, etc.), etc.

At operation 1070, an occurrence of a content presentation trigger is identified, such as in a manner described herein.

At operation 1075, a second content item is presented, e.g., in response to identification of the occurrence of the content presentation trigger (e.g., at operation 1070).

At operation 1080, one or more user interactions are identified, e.g., in relation to a presentation of the first content item.

At operation 1085, a second content item that corresponds to the one or more user interactions as identified in relation to the first content item is identified.

At operation 1090, the second content item (e.g., as identified at operation 1085) is presented, such as in a manner described herein.

Further aspects of these (and other) operations and functions of the described technologies are described in detail herein.

Additionally, further operations of the referenced technologies include: presenting/projecting a first content item, capturing one or more images, processing, by a processing device, the one or more images to identify one or more user interactions (or lack thereof) in relation to the first content item, identifying a second content item that corresponds to the one or more user interactions as identified in relation to the first content item, and projecting the second content item. Further aspects of these (and other) operations are described in greater detail herein. It should be understood that, in certain implementations, various aspects of the referenced operations can be performed by content presentation device 112, device 102, content presentation engine 130 and/or server 120, while in other implementations such aspects may be performed by one or more other elements/components, such as those described herein.

In certain implementations the described technologies can enable or facilitate various interactions with the content being projected (e.g., by content presentation device 112). For example, in certain implementations such interactions can be enabled via techniques such as gesture recognition (e.g., recognition of various human motions via the referenced camera and/or other sensors). Various other forms of recognition can also be integrated. For example, facial recognition, voice recognition, eye tracking and lip movement recognition (collectively, a perceptual user interface (PUI)) can be utilized to enable interaction with the projected content.

The referenced recognition techniques (which, as noted, can be enabled via inputs received from camera(s) and/or other sensors and processed to detect motion, etc.) can be used for data collection, live visuals, and interaction between the viewers and the system. Additionally, the referenced techniques (e.g., facial recognition) can be used to adjust or personalize the content being presented. For example, upon determining (e.g., using facial recognition and/or other such techniques) that a particular viewer is likely to be a particular gender, age, demographic, etc., various aspects of the content being displayed can be customized or adjusted (e.g., by depicting products, services, content etc. that are targeted to the determined gender, age, etc., of the viewer), as described in greater detail below.

As noted above, in certain implementations an integrated and/or connected sensor (e.g., camera 113 as shown in FIG. 1) can be used to capture image(s) of the general area upon which the content is to be projected (e.g. a storefront window 116). The captured image(s) can be processed (whether at a local device and/or remotely, e.g., at server 120) to identify the location of one or more content presentation surfaces 114 (e.g., films affixed to window 116). Upon identifying the location (and shape) of the referenced films, the content to be presented can be adjusted to ensure that it is presented appropriately/optimally on the films. For example, the center of the content can be aligned with the center of a film, the content can be cropped or altered to fit within the size/shape of the film, etc. Additionally, in certain implementations an integrated or connected accelerometer can be utilized to detect or otherwise determine the angle at which content presentation device 112 (e.g., a projector) is positioned. Based on a determination of the referenced angle, the content to be projected can be modified accordingly (e.g., to ensure that the content is visible and/or presented accurately/consistently).

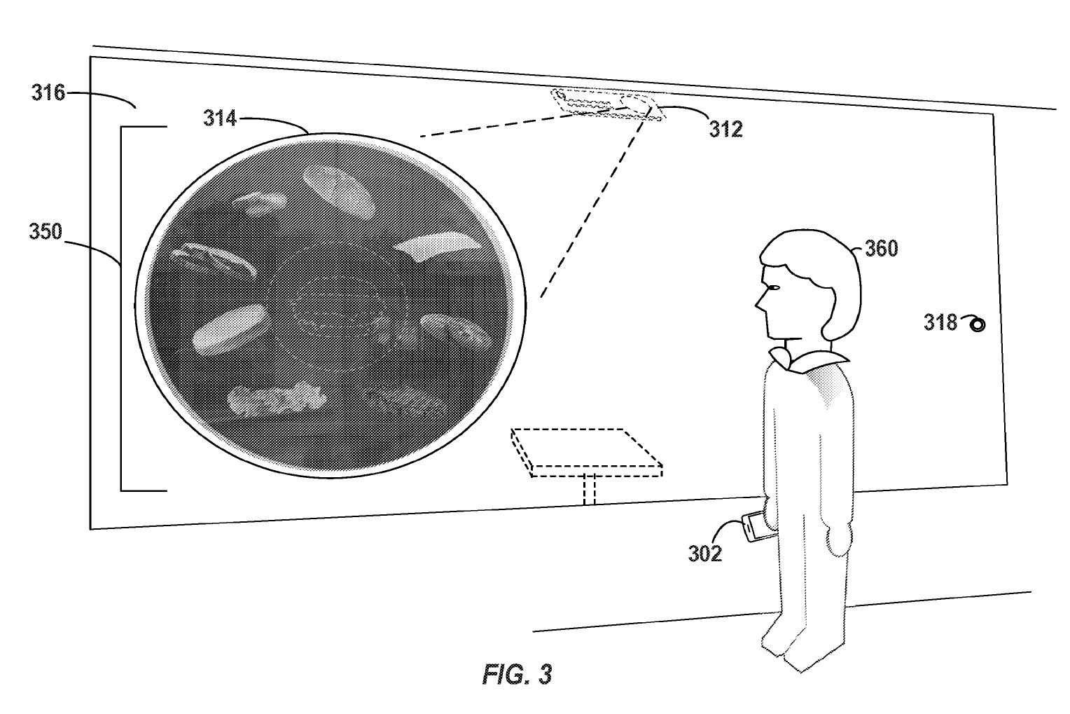

By way of illustration, FIG. 3 depicts example interactive content 350 as projected on content presentation surface 314 (here a film) applied to window 316 (here, of a restaurant). As shown in FIG. 3, user 360 can pass by window 316, e.g., when walking past the restaurant. As shown in FIG. 3, upon detecting the presence of user 360 (e.g., based on inputs received at camera/image sensor 318), content 350 (e.g. from content repository 140) can be presented to the user. For example, various ingredients (hamburger, tomato, etc.) can be shown in different areas. Using gesture-based interactions (e.g., as detected by camera 318), user 360 can interact with the depicted content 350, e.g., to select those ingredients the user is interested in. For example, using a ‘swipe’ hand gesture, user 360 can select and drag an ingredient towards the center region, thereby generating/assembling a restaurant order. Upon completing their order, a QR code can be presented, through which the user (via their device 302, e.g., a smartphone) can complete the order/purchase (e.g., via a checkout link/application). Alternatively, in certain implementations the depicted 350 (e.g., ingredients such as a hamburger, tomato, etc.) can be presented in a ‘disassembled’ manner (as shown) when no users are standing near the display. Upon detecting (e.g., via sensor 318) that user 360 is approaching window 316, the ingredients can be ‘assembled’ into a hamburger sandwich.

FIG. 4 depicts a further example implementation of the described technologies. As shown in FIG. 4, content 450 (e.g., images/videos of the ‘bodies’ of the depicted characters) can be retrieved (e.g., from content repository 140) and modified to incorporate characteristics (here, faces) of various users (e.g., user 460) that may be standing in front of window 416 (which may be captured by embedded and/or connected cameras, e.g., camera 418 as shown). Additionally, the described technologies can be used to identify/select characters that may be appropriate for a particular user/viewer. For example, upon determining that a particular viewer is a female, her face can be embedded within the body of a female character.

Moreover, in certain implementations the level or degree of engagement of a user can be determined. For example, a user standing (e.g., not moving) in front of a window and facing/looking towards it can be determined to be likely to be engaged by the content being presented on the window, while a user walking by a window (and not looking at it) can be determined to be relatively unlikely to be engaged by the content being displayed. Accordingly, in certain implementations the described technologies can be configured to determine such a degree of engagement of one or more users (e.g., using facial recognition, etc.). Additionally, the content being depicted can be selected/modified accordingly. For example, upon determining that a particular user is not engaged in the content being presented (e.g., is walking by a window), content that is configured to get the user's attention (e.g., with bright lights, colors, promotional information, etc.) can be projected/presented, in order to get the viewer's attention and encourage them to further engage with the displayed content.

Various chronological aspects can also be defined with respect to a content presentation. For example, a schedule 145 can be defined with respect to multiple content items, reflecting time(s) at which each content item is to be presented.

Additionally, in certain implementations the described technologies can be utilized to present/project multiple content items (e.g., on multiple content presentation surfaces such as films and/or regions thereof). For example, FIG. 5 depicts an example scenario in which multiple users 560A, 560B, and 560C are passing by/standing in front of window 516 (or another such surface), e.g., of a restaurant. Upon identifying/determining the presence of such users and/or that such users are viewing or otherwise interested in the display, various content items 550A, 550B can be identified, selected, and/or presented (e.g., on respective content presentation surfaces that are opposite each respective user). For example, images and/or other content (audio, video, etc.) captured by sensor/camera 518 can be processed to determine the number of users standing in front of window 516, the relative/absolute location of each user, information regarding each user such as demographic information, etc.). For example, as shown in FIG. 5, the described technologies can configure a single content presentation device 512 (e.g., a projector) to can project/present different content items onto different areas/regions of one or more window(s). As noted above, the content presented to each user (or set of users) can be selected, formatted, configured, etc., based on aspects, features, characteristics, etc., identified with respect to such a user. For example, upon determining that users 560A and 560B are likely to correspond to a parent and a young child, content 550A (corresponding to one adult and one child character) can be identified and projected/presented to the user(s) (e.g., on the content presentation surface closest or most visible to such user(s). By way of further example, upon determining that user 560C is likely to correspond to a 28 year-old male, content 550B (corresponding to a character determined to be popular with users in the referenced demographic) can be identified and projected/presented to the user 560C (e.g., on the content presentation surface 514B closest or most visible to such user).

In certain implementations, the content presented by the described technologies (e.g., in each respective region) can be interacted within (e.g., in a manner described herein) independently by different users.

As noted above, in certain implementations the described technologies can enable interaction (e.g., with displayed content) via one or more user devices (e.g., smartphones). For example, a connection between a viewer's smartphone and a content presentation device (e.g., projector, screen, etc.) can be established in any number of ways, e.g., via a custom URL, scanning a QR code being projected, an application executing on the smartphone, Bluetooth, WiFi, etc.

By way of illustration, FIG. 6A depicts a scenario in which content 650A is projected/displayed by content presentation device 612, e.g., onto content display surface 614 affixed to window 616. As shown in FIG. 6A, such content can provide a QR code and/or URL that, when accessed by a device (e.g., device 602 of user 660), enables interaction with and/or control of the content being displayed. Utilizing such a QR code, URL, etc. can establish a connection/communication channel between device 602 and content presentation device 612.

Upon establishing such a connection between user device (e.g., a smartphone) and a content presentation device, the user can be provided with various additional functionality. Such functionality can, for example, enable the user to control or interact with the displayed content via an app or browser on the device 602. By way of illustration, device 602 can present an interface or set of controls through which user 660 can interact with and/or control content being presented (e.g., content 650B, corresponding to a video game, as shown in FIG. 6B). For example, as shown in FIG. 6B, device 602 can provide a selectable control and/or other such interface(s) (e.g., graphical user interfaces) that user 660 can utilize to play a video game presented/projected by content presentation device 612.

It should be understood that the depicted/described scenario(s) are provided by way of illustration. Accordingly, the described technologies can also be implemented in any number of other contents, settings, etc. For example, the described technologies can enable a user to utilize their user device (e.g., smartphone) to user to select content to be presented via content presentation device (e.g., a projector, display, etc.). By way of illustration, a user can utilize his/her smartphone to select a video or other such content to be presented/projected by a content presentation device. By way of further illustration, a user can utilize his/her smartphone to interact with content presented by a content presentation device (e.g., to change the color, style, etc., of the clothing depicted by a content presentation device displayed in a storefront window.

It should also be noted that, in certain implementations, the referenced connection between the described technologies (e.g., a content presentation device such as a projector, display, etc.) and user device(s) (e.g., smartphones of respective users that are viewing the content being projected) can be utilized to create/maintain a queue, e.g., for games that may be played via the described technologies. For example, multiple users wishing to play a video game being projected on a window/screen (e.g., as shown in FIG. 6B) can enter a gameplay queue (maintained by the system, e.g., via a corresponding URL, QR code, etc.). Such users can further be alerted (e.g., via notifications directed to/provided at their respective devices and/or via content presentation device 612) when their turn to play is approaching/has arrived.

The described technologies (e.g., analysis engine 132) can also enable the collection and analysis of data/information that reflects various aspects of the exposure of the content being presented. In certain implementations, the manner in which users/viewers react/respond to such content and the manner in which the system is interacted with can also be determined and/or analyzed, and records of such reactions, etc., can be maintained (e.g., in log 142). In doing so, numerous forms of data analysis can be applied (e.g., AB testing, etc.), such as in order to improve the degree of user engagement (e.g., by presenting content determined to be of interest at a particular time in a particular location). The referenced analytics can be monitored in real-time, and users (e.g., administrators) can adjust various aspects of the content presentation based on various determinations (e.g., increasing the frequency of a particular video being played that is determined to be relatively more engaging/interesting to users passing by). Alternatively, such adjustments can be made in an automated/automatic fashion (based on the referenced determinations and/or further utilized various machine learning techniques), without the need for manual input.

By way of further illustration, analysis engine 132 can also generate various types of analytics, reports, and/or other such determinations that provide insight(s) into the effectiveness of the described technologies. Examples of such analytics include but are not limited to: an estimate/average of the number of people that passed by a store's window, content display device, etc. (e.g., per hour, day, week, etc.), an estimate/average of the dwell time for the people that view the window (reflecting the amount of time viewers remained stationary and/or were engaged with the content being presented (e.g., 10 seconds, 30 seconds, etc.), approximate age and gender of the people that view the window, etc.

Additionally, in certain implementations analysis engine 132 can enable a user (e.g., an administrator) to filter and rank various metrics, analytics, results, etc. For example, in certain implementations a content presentation device (e.g., a projector installed to project content on a storefront window) can present a broad range of content (e.g., text content, images, videos, interactive content, games, etc.). Accordingly, based on various user responses, feedback, and/or other such determinations (e.g., as determined in a manner described herein and stored in log 142), analysis engine 132 can determine, for example, which content (or types of content) generates the most engagement, interest, interaction, longest view times, etc., overall and/or with respect to certain demographics, etc. Upon computing such determination(s), the described technologies can further adjust or configure various aspects of the described content presentation, e.g., in order to improve or optimize user engagement, content dissemination/exposure, and/or other metrics/factors (including but not limited to those described herein).

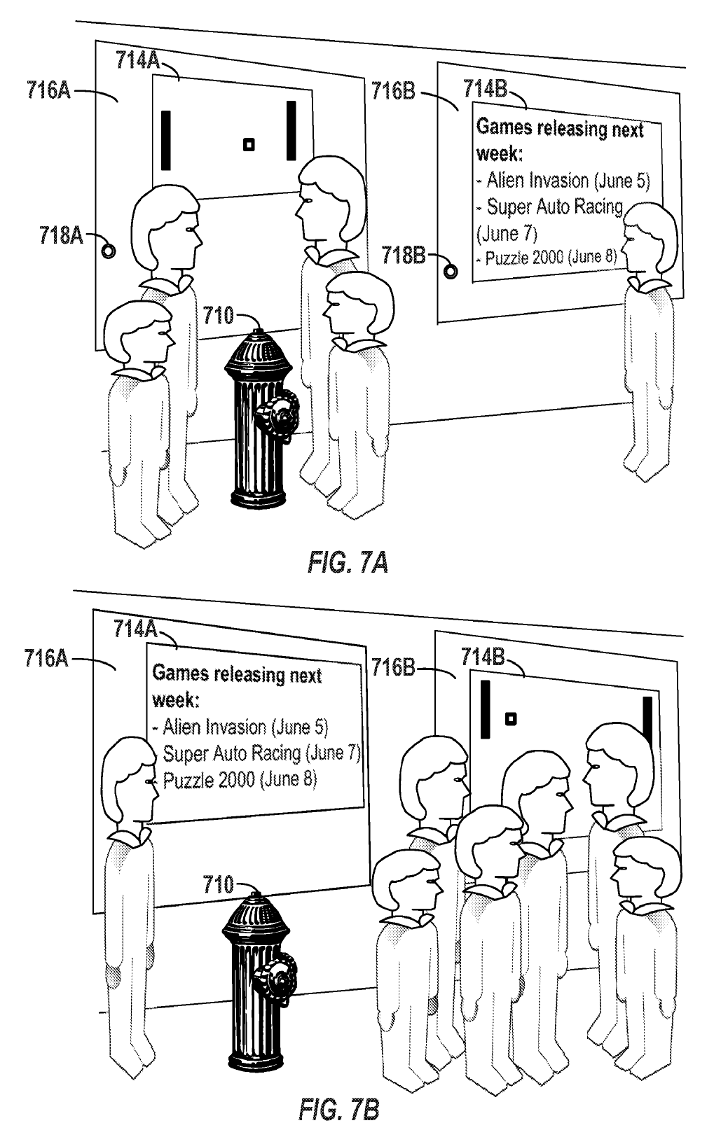

It should be understood that such engagement can be determined, for example, based on the number of viewers, amount of time such viewers remain to continue to watch, subsequent actions performed by such users (e.g., entering the store) etc. As noted above, such determination(s) can be computed based on inputs based on inputs originating from sensor (e.g., camera 718A as shown in FIG. 7A).

By way of illustration, FIG. 7A depicts an example scenario of a store (or any other such structure, location, etc.) having multiple content presentation surfaces (here, window 716A and window 716B). As shown in FIG. 7A, a fire hydrant 710 (or any other such obstruction) is positioned opposite window 716A. As also shown in FIG. 7A, the content being presented/projected onto film/surface 714A (here, a live video game) is attracting a substantial amount of user engagement. In contrast, the content presented at film/surface 714B (“Games releasing . . . ”) is generating substantially less engagement (e.g., only one viewer, as compared to four viewers for the content presented on surface 714A). It can also be appreciated that surface/film 714A (on which the live video game is presented) is substantially smaller than surface 714B (despite surface 714A presenting more engaging content in FIG. 7A).

Accordingly, upon determining (e.g., in the scenario depicted in FIG. 7A) that (a) content presented on surface 714A (a live video game) is generating significant user engagement, (b) the fire hydrant may be preventing further engagement (e.g., by other users), and (c) content presented on surface 714B is generating significant user engagement, the described technologies can initiate various actions, adjustments, etc., as described herein. In doing so, the various available content presentation (and other) resources can, for example, be utilized in a more efficient and/or effective manner.

By way of further illustration, FIG. 7B depicts a subsequent scenario in which the content presented in respective windows 716A, 716B is switched or swapped. In doing so, content that is more engaging (and may attract more viewers) can be displayed at window 716B (which, as noted, includes film 714B which is substantially larger than film 714A, thus enabling a greater number of viewers to comfortably view the presented content). Since there is no obstruction (e.g., fire hydrant 710) present opposite the window, a substantial number of users/viewers can stand in front of the window and view the content simultaneously. For example, as shown in FIG. 7B, a greater number of users/viewers (here, six, as opposed to only four in FIG. 7A) are now able to view the referenced content (live video game). With respect to window 716A (which is opposite fire hydrant), the depicted “Games releasing . . . ” content can be presented. In doing so, such content can continue to be presented in a manner/context that enables further user engagement while freeing up resource(s) (e.g., those associated with content presentation, as described herein) that can be utilized more effectively.

As noted above, analysis engine 132 can generate and/or provide various analytics, metrics, etc., that reflect various aspects of user traffic (e.g., the number of users passing by a particular location), user engagement (e.g., the number of users that viewed certain presented content, e.g., for at least a defined period of time), etc.

Additionally, analysis engine 132 can further generate and/or provide various interfaces (e.g., graphical user interfaces, reporting tools, etc.) through which a user (e.g., an administrator) can query, view, etc., such metrics. By way of illustration, analysis engine can provide an interface that displays metrics such as the number of viewers (e.g., at a particular time, location, etc.), amount of time such viewers remain to continue to watch, subsequent actions performed by such users (e.g., entering the store after viewing presented content), etc.

Moreover, various metrics can also be generated/presented with respect to different pieces of content. That is, it can be appreciated that, in certain implementations, the described technologies can enable various content presentation schedules or routines to be defined. Such routines/schedules dictate the manner in which content is to be presented (e.g., by a content presentation device). By way of illustration, such a schedule can include a timeline that reflects various pieces of content (e.g., images, videos, text, interactive content, etc.), and the sequence, duration, etc., that such content items are to be presented. Accordingly, the described technologies can further track and provide metrics/analytics with respect to respective content item(s) (reflecting, for example, that one video in a sequence was effective that another in engaging users, etc.). It should be understood that the various metrics referenced herein can also be filtered, sorted, etc. by date range, time of day, day of the week, etc. (e.g., number of people that viewed a display on weekdays between 12 and 4 pm). Such metrics can further be aggregated (e.g., across multiple content presentation systems or ‘kits,’ by store, region, and/or other groupings).

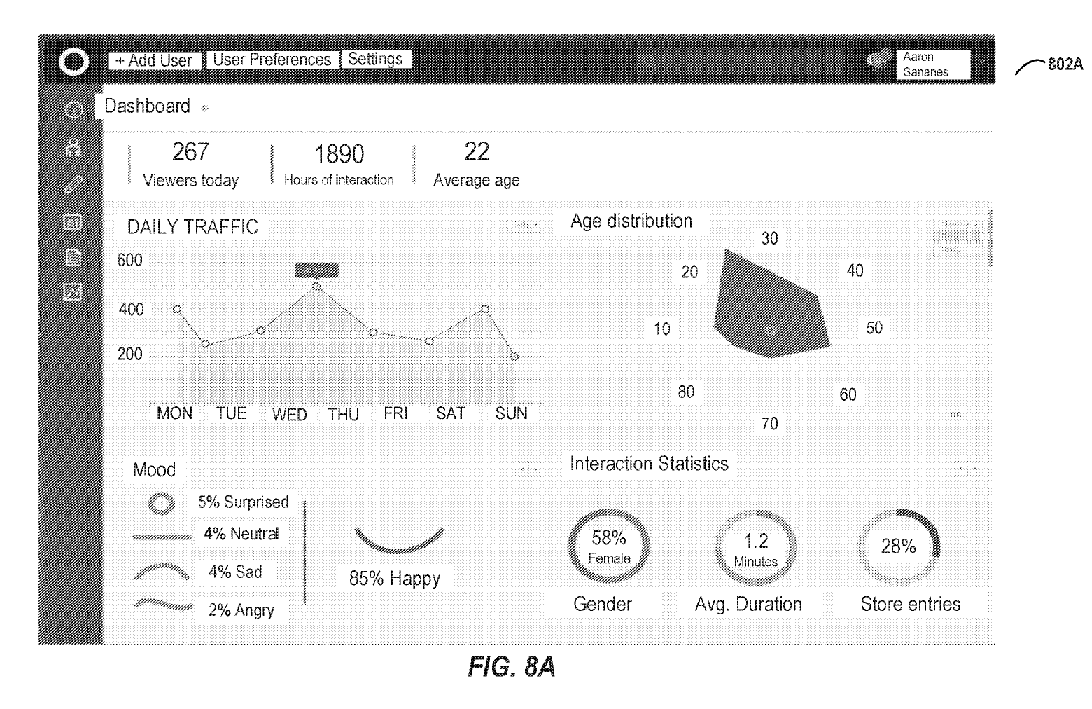

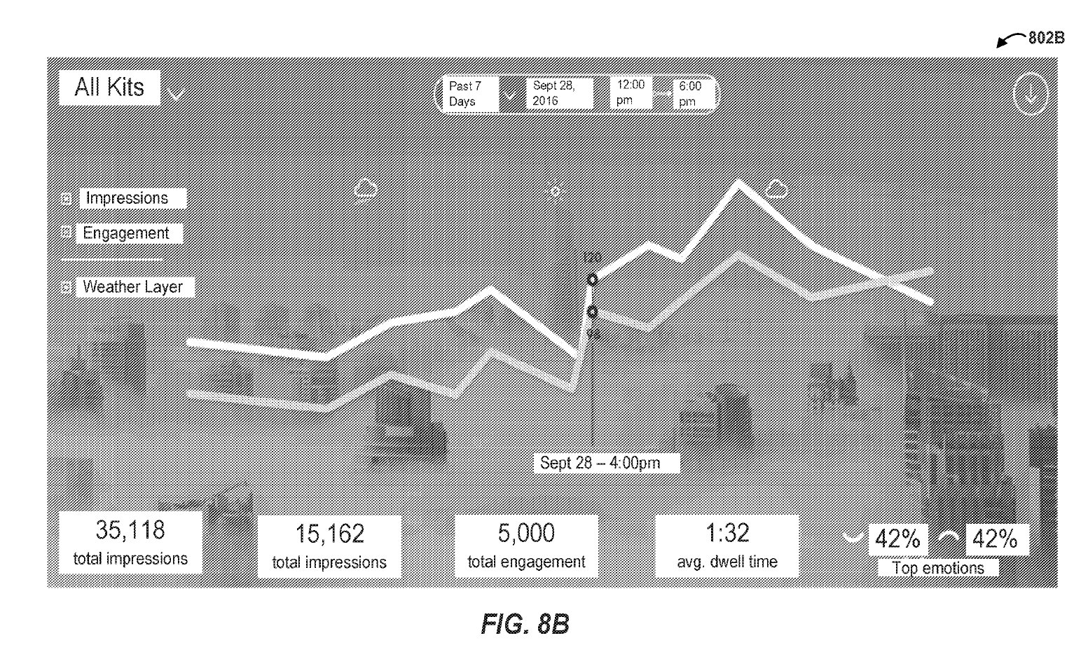

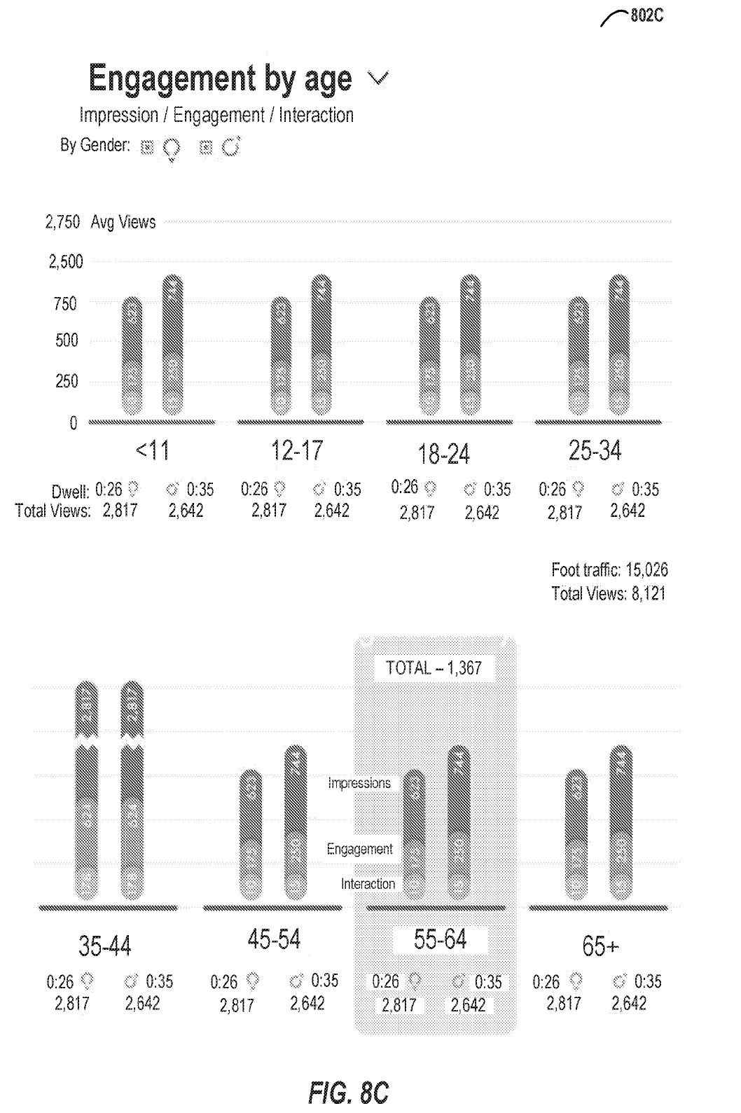

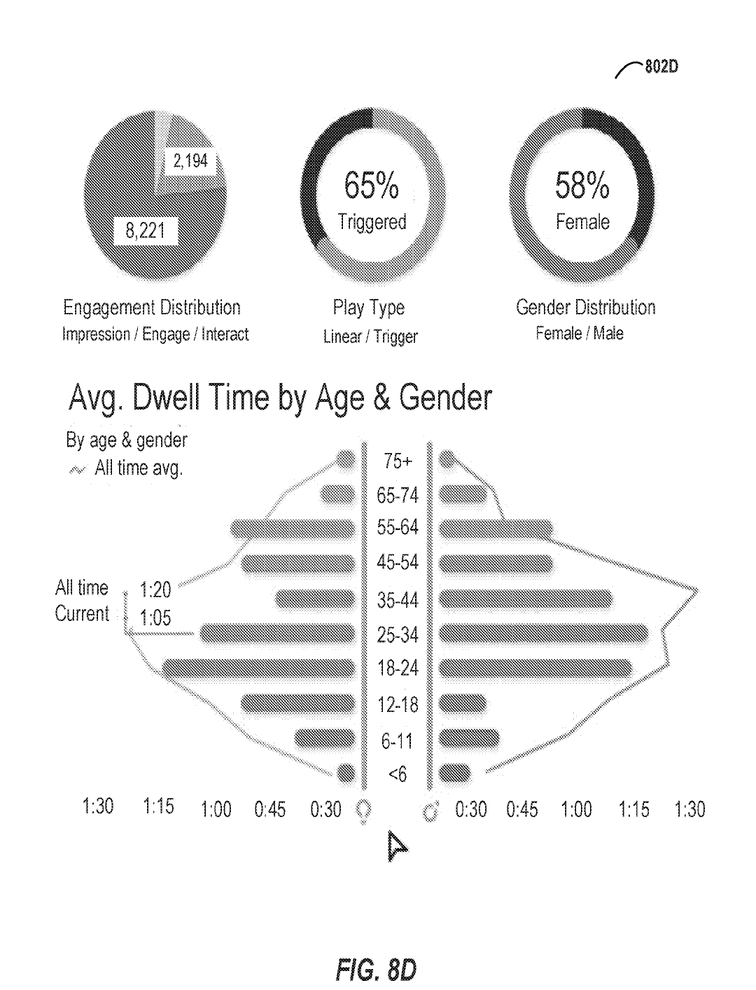

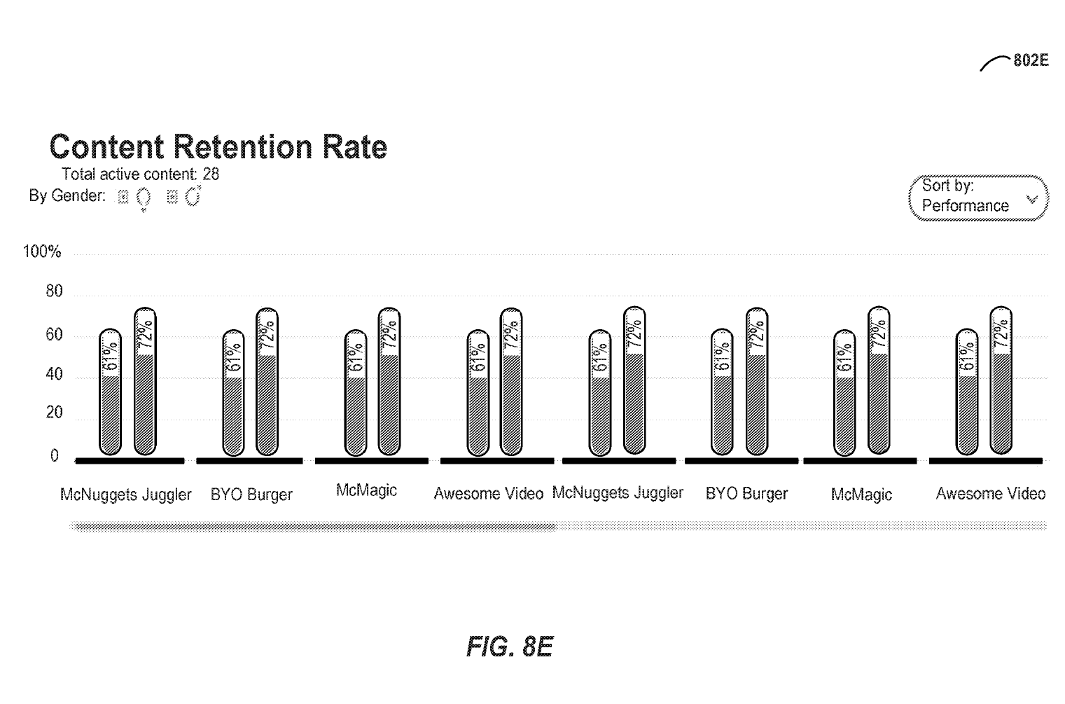

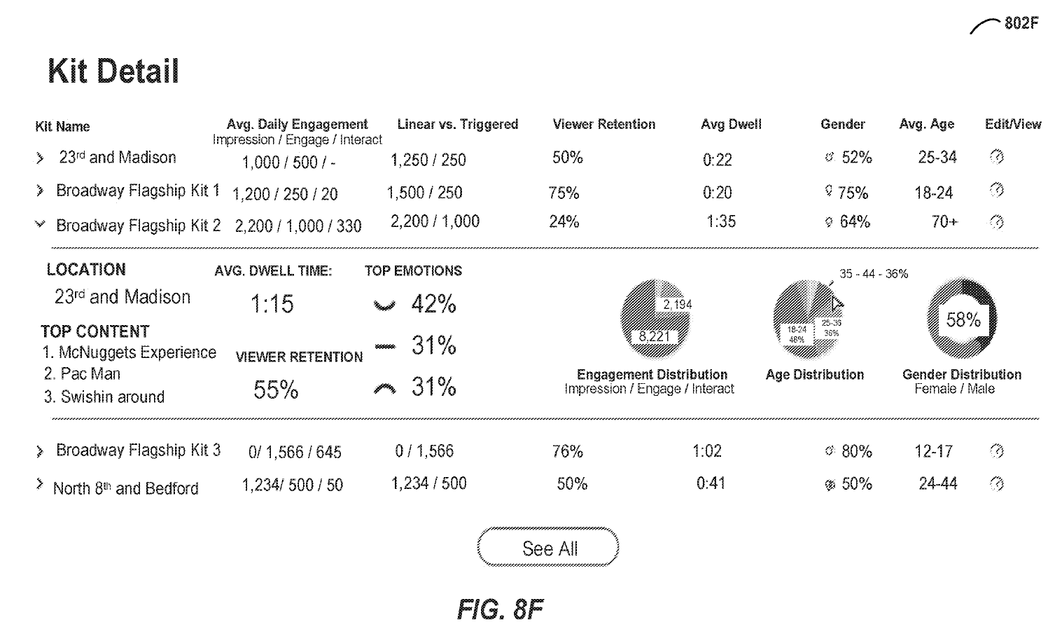

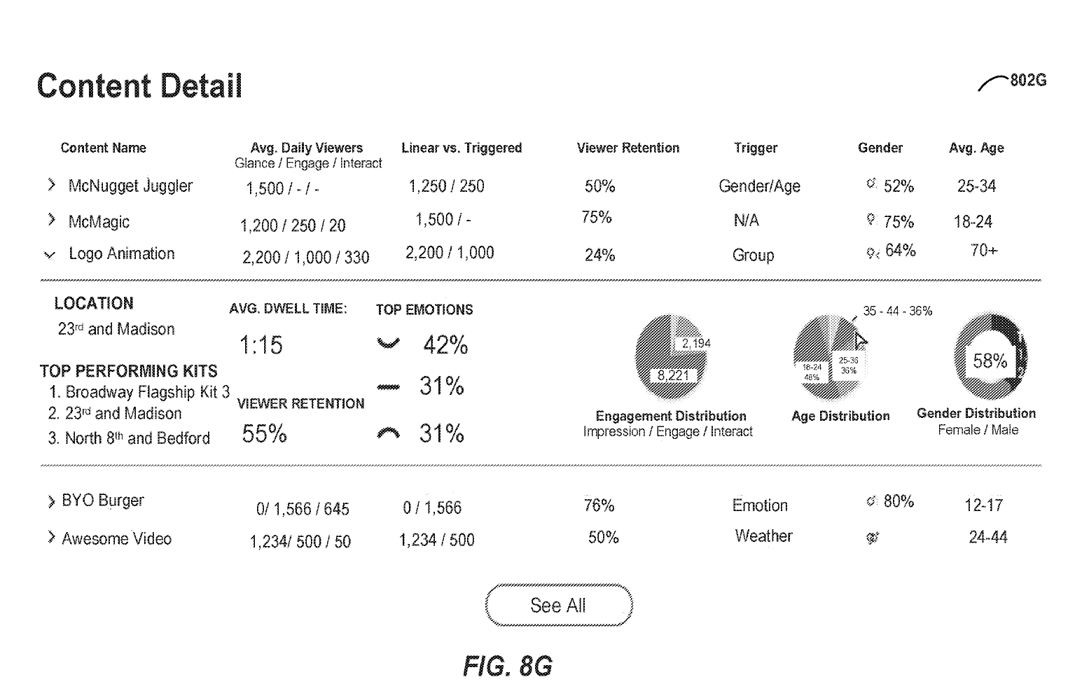

By way of illustration, FIG. 8A depicts an example user interface 802A (e.g., a dashboard) that can be generated by analysis engine 132 and presented, provided, and/or accessed by a user (e.g., a content administrator). As shown in FIG. 8A, various reports, statistics, etc., can be generated based on data collected by the described technologies (e.g., as stored in log 142). As noted above, such data can be collected/received via sensor(s) (e.g., image sensor(s)) positioned at/in proximity to a window or other such content presentation surface (e.g., camera 318 as depicted in FIG. 3 and described herein).

For example, as shown in FIG. 8A, metrics such as the number of viewers on a given day, number of hours of interaction, average age of viewers, age distribution of viewers, gender of viewers, interaction duration, and daily traffic can be determined and presented. Additionally, using facial recognition techniques (e.g., with respect to images captured by sensor/camera 318 as depicted in FIG. 3) the mood(s) and/or responses of the viewers of various content can be determined and tracked. As also shown, statistics regarding the number of viewers that subsequently performed a particular activity (e.g., entered a location/store after viewing presented content) can also be determined, tracked, and presented. Additionally, as noted above, the described metrics can be computed with respect to respective content items, presentations, applications, etc. In doing so, it can be determined or otherwise computed which types of content are most effective in order to achieve or improve a particular outcome (e.g., to increase traffic/user entries into the store when the store is open, increase ecommerce orders when the store is closed, improve viewers' moods, etc.).

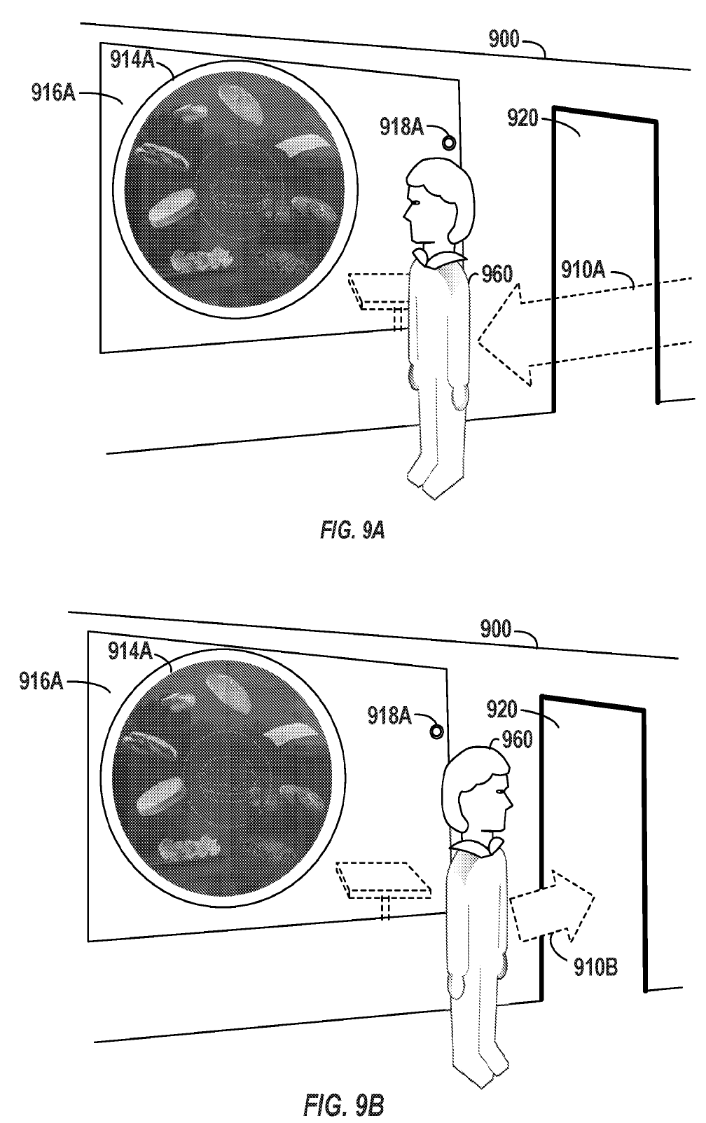

In certain implementations, the described technologies can also track various conversions that can be attributed to content being displayed. Such conversions can reflect actions, interactions, transactions, etc., that can be attributed to the content being presented (e.g., as described herein). By way of illustration, FIG. 9A depicts an example scenario in which user 960 is walking past restaurant 900 along path 910A. As shown in FIG. 9A, images can be captured by sensor 918A (e.g., a camera) reflecting user 960 has walked past entrance/door 920 (suggesting that the user is not initially interested in entering the restaurant). However, it can be further determined (based on images, video, etc. captured by sensor 918A) that upon viewing content presented on window/surface 916A and/or film 914A, user 960 reverses course and walks towards/into entrance 920 (e.g., along path 910B as shown in FIG. 9B). By detecting/determining that the user has changed the direction in which he/she is walking after viewing (and/or interacting with) presented content (e.g., initially from right to left as in FIG. 9A, and then from left to right as in FIG. 9B), such user activity can be ascribed/attributed to the content presented to the user.

FIG. 8B depicts another example user interface 802B that can be generated by analysis engine 132 and presented, provided, and/or accessed by a user (e.g., a content administrator). As shown in FIG. 8B, various charts or trends can be computed, reflecting the number of impressions (e.g., the number of times content was presented to a user) over the course of a certain time period, and/or an amount of engagement by users to whom content is presented. Such engagement can include but is not limited to stopping and viewing content (e.g., for a defined period of time or longer), performing an action (e.g., going into a store/location), interacting with the content being presented, etc. As noted, such impressions and engagement can be determined/tracked based on images (or other data) captured/received by various sensor(s) (e.g., camera 318 as depicted in FIG. 3). It should also be noted that, as shown in FIG. 8B, user interface 802B can further incorporate/depict aspects of the weather in conjunction with the referenced metrics. For example, an icon or other such indictor reflecting the weather at the location of the content presentation device (with respect to which the referenced metrics are computed) can be shown at points along the referenced graph(s). Doing so can enable a user to further account for weather-related factors when, for example, determining whether or not a content presentation campaign was/was not successful (e.g., low engagement on a rainy day may be on account of the rain, not sub-optimal content).

Moreover, FIG. 8C depicts another example user interface 802C that can be generated by analysis engine 132 and presented, provided, and/or accessed by a user (e.g., a content administrator). As shown in FIG. 8C, the referenced interface/tool can further break down information pertaining to instances of content presentation (‘impressions’), engagement, and/or interaction, e.g., by various factors/characteristics (here, an age range computed based on a determination/estimation performed based on a captured image of the user).

As shown in FIG. 8D, in certain implementations the distribution of various information, phenomena, etc., can be determined and presented (e.g., within user interface 802D, as shown). For example, the average ‘dwell time’ (e.g., the amount of time a user remains in front of a content presentation device/surface (e.g., when viewing content) can be determined, e.g., with respect to respective genders, age ranges, and/or other such demographics, characteristics, etc. As noted above, the determination of a gender, age, etc., of a user can be computed using various image processing techniques.

In certain implementations, various metrics such as a content retention rate can be computed. For example, FIG. 8E depicts an example user interface 802E depicting the retention rate of various content items (e.g., different videos, images, multimedia presentations, interactive content, etc.), further broken down by gender (for each content item). Such a content retention rate can reflect, for example, the rate at which users/viewers are retained (that is, the user remains until conclusion of the presentation of the content item rather than walking or turning away while the content item is still being presented) when presented with a particular content item.

FIG. 8F depicts an example user interface 802F that depicts various information pertaining to particular content presentation devices/installations (‘kits’). For example, as described above, the described technologies can enable the coordination and management of content presentations across various installations of content presentation devices (projectors, displays, etc.) at different locations. Accordingly, interface 802F presents various metrics that reflect the performance of the described technologies, user distribution, etc. at different locations.

Moreover, FIG. 8G depicts an example user interface 802G that depicts various information pertaining to particular content items (e.g., different videos, images, multimedia presentations, interactive content, etc.). For example, as shown, the described technologies can determine which content items/types of content perform well (or poorly) at which locations, with respect to which types of users.

As depicted in FIG. 1 and described herein, multiple content display devices/systems (e.g., displays, projectors, associated devices/sensors, etc.) can be deployed across multiple locations (e.g., in different cities, states, etc.). The described technologies can enable centralized control and updating of the content to be displayed on such distributed systems. In doing so, the described technologies (in an automated/automatic fashion and/or as configured by a content administrator) can ensure that the content being displayed on displays across many geographic areas is constantly up to date and consistent across multiple locations.

Additionally, the described analytics functionality (e.g., as provided by analysis engine 132) can enable determinations computed with respect to one location/content presentation device to be leveraged with respect to another device/location. For example, upon determining that a particular type of content (e.g., a video, presentation, game, application, etc.) is particularly engaging to users in one location, such content can also be presented in other locations.

By way of illustration, the described technologies can be employed in contexts including but not limited to: retail/store window displays (e.g., to enable the promotion of store products, special offers, fun attractions, etc.—while the store is open as well as while it is closed), empty retail locations (thereby utilizing an otherwise empty store window as advertising space, and/or presenting potential retail opportunities for the space, real estate diagrams, etc.), real estate (e.g., showing a grid of properties), at construction sites (e.g., on the fence—showing advertising, information re: what's being built at the site, etc.), restaurants (e.g., depicting menu items, promotions, etc.), banks (depicting various banking services and/or promotions), etc.

At this juncture it should be noted that while various aspects of the described technologies may involve various aspects of monitoring or tracking user activity or information, in certain implementations the user may be provided with an option to opt-out or otherwise control or disable such features. Additionally, in certain implementations any personally identifiable information can be removed or otherwise treated prior to it being stored or used in order to protect the identity, privacy, etc. of the user. For example, identifying information can be anonymized (e.g., by obscuring user's faces in video/images that are stored, etc.).

It should also be noted that while the technologies described herein are illustrated primarily with respect to interactive content presentation, the described technologies can also be implemented in any number of additional or alternative settings or contexts and towards any number of additional objectives. It should be understood that further technical advantages, solutions, and/or improvements (beyond those described and/or referenced herein) may be enabled as a result of such implementations.

It should also be noted that while the technologies described herein are illustrated primarily with respect to interactive content management, the described technologies can also be implemented in any number of additional or alternative settings or contexts and towards any number of additional objectives. It should be understood that further technical advantages, solutions, and/or improvements (beyond those described and/or referenced herein) can be enabled as a result of such implementations.

Certain implementations are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example implementations, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some implementations, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module can also include programmable logic or circuitry that is temporarily configured by software to perform certain operations. For example, a hardware module can include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering implementations in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor can be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In implementations in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API).

The performance of certain of the operations can be distributed among the processors, not only residing within a single machine, but deployed across a number of machines. In some example implementations, the processors or processor-implemented modules can be located in a single geographic location (e.g., within a home environment, an office environment, or a server farm). In other example implementations, the processors or processor-implemented modules can be distributed across a number of geographic locations.

The modules, methods, applications, and so forth described in conjunction with FIGS. 1-10 are implemented in some implementations in the context of a machine and an associated software architecture. The sections below describe representative software architecture(s) and machine (e.g., hardware) architecture(s) that are suitable for use with the disclosed implementations.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture can yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

FIG. 11 is a block diagram illustrating components of a machine 1100, according to some example implementations, able to read instructions from a machine-readable medium (e.g., a machine-readable storage medium) and perform any one or more of the methodologies discussed herein. Specifically, FIG. 11 shows a diagrammatic representation of the machine 1100 in the example form of a computer system, within which instructions 1116 (e.g., software, a program, an application, an applet, an app, or other executable code) for causing the machine 1100 to perform any one or more of the methodologies discussed herein can be executed. The instructions 1116 transform the general, non-programmed machine into a particular machine programmed to carry out the described and illustrated functions in the manner described. In alternative implementations, the machine 1100 operates as a standalone device or can be coupled (e.g., networked) to other machines. In a networked deployment, the machine 1100 can operate in the capacity of a server machine or a client machine in a server-client network environment, or as a peer machine in a peer-to-peer (or distributed) network environment. The machine 1100 can comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1116, sequentially or otherwise, that specify actions to be taken by the machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 can include processors 1110, memory/storage 1130, and I/O components 1150, which can be configured to communicate with each other such as via a bus 1102. In an example implementation, the processors 1110 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) can include, for example, a processor 1112 and a processor 1114 that can execute the instructions 1116. The term “processor” is intended to include multi-core processors that can comprise two or more independent processors (sometimes referred to as “cores”) that can execute instructions contemporaneously. Although FIG. 11 shows multiple processors 1110, the machine 1100 can include a single processor with a single core, a single processor with multiple cores (e.g., a multi-core processor), multiple processors with a single core, multiple processors with multiples cores, or any combination thereof.

The memory/storage 1130 can include a memory 1132, such as a main memory, or other memory storage, and a storage unit 1136, both accessible to the processors 1110 such as via the bus 1102. The storage unit 1136 and memory 1132 store the instructions 1116 embodying any one or more of the methodologies or functions described herein. The instructions 1116 can also reside, completely or partially, within the memory 1132, within the storage unit 1136, within at least one of the processors 1110 (e.g., within the processor's cache memory), or any suitable combination thereof, during execution thereof by the machine 1100. Accordingly, the memory 1132, the storage unit 1136, and the memory of the processors 1110 are examples of machine-readable media.

As used herein, “machine-readable medium” means a device able to store instructions (e.g., instructions 1116) and data temporarily or permanently and can include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 1116. The term “machine-readable medium” shall also be taken to include any medium, or combination of multiple media, that is capable of storing instructions (e.g., instructions 1116) for execution by a machine (e.g., machine 1100), such that the instructions, when executed by one or more processors of the machine (e.g., processors 1110), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1150 can include a wide variety of components to receive input, provide output, produce output, transmit information, exchange information, capture measurements, and so on. The specific I/O components 1150 that are included in a particular machine will depend on the type of machine. For example, portable machines such as mobile phones will likely include a touch input device or other such input mechanisms, while a headless server machine will likely not include such a touch input device. It will be appreciated that the I/O components 1150 can include many other components that are not shown in FIG. 11. The I/O components 1150 are grouped according to functionality merely for simplifying the following discussion and the grouping is in no way limiting. In various example implementations, the I/O components 1150 can include output components 1152 and input components 1154. The output components 1152 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example implementations, the I/O components 1150 can include biometric components 1156, motion components 1158, environmental components 1160, or position components 1162, among a wide array of other components. For example, the biometric components 1156 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1158 can include acceleration sensor components (e.g., accelerometer), gravitation sensor components, rotation sensor components (e.g., gyroscope), and so forth. The environmental components 1160 can include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that can provide indications, measurements, or signals corresponding to a surrounding physical environment. The position components 1162 can include location sensor components (e.g., a Global Position System (GPS) receiver component), altitude sensor components (e.g., altimeters or barometers that detect air pressure from which altitude can be derived), orientation sensor components (e.g., magnetometers), and the like.

Communication can be implemented using a wide variety of technologies. The I/O components 1150 can include communication components 1164 operable to couple the machine 1100 to a network 1180 or devices 1170 via a coupling 1182 and a coupling 1172, respectively. For example, the communication components 1164 can include a network interface component or other suitable device to interface with the network 1180. In further examples, the communication components 1164 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1170 can be another machine or any of a wide variety of peripheral devices (e.g., a peripheral device coupled via a USB).

Moreover, the communication components 1164 can detect identifiers or include components operable to detect identifiers. For example, the communication components 1164 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information can be derived via the communication components 1164, such as location via Internet Protocol (IP) geolocation, location via Wi-Fi® signal triangulation, location via detecting an NFC beacon signal that can indicate a particular location, and so forth.

In various example implementations, one or more portions of the network 1180 can be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1180 or a portion of the network 1180 can include a wireless or cellular network and the coupling 1182 can be a Code Division Multiple Access (CDMA) connection, a Global System for Mobile communications (GSM) connection, or another type of cellular or wireless coupling. In this example, the coupling 1182 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1116 can be transmitted or received over the network 1180 using a transmission medium via a network interface device (e.g., a network interface component included in the communication components 1164) and utilizing any one of a number of well-known transfer protocols (e.g., HTTP). Similarly, the instructions 1116 can be transmitted or received using a transmission medium via the coupling 1172 (e.g., a peer-to-peer coupling) to the devices 1170. The term “transmission medium” shall be taken to include any intangible medium that is capable of storing, encoding, or carrying the instructions 1116 for execution by the machine 1100, and includes digital or analog communications signals or other intangible media to facilitate communication of such software.

Throughout this specification, plural instances can implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

Although an overview of the inventive subject matter has been described with reference to specific example implementations, various modifications and changes can be made to these implementations without departing from the broader scope of implementations of the present disclosure. Such implementations of the inventive subject matter can be referred to herein, individually or collectively, by the term “invention” merely for convenience and without intending to voluntarily limit the scope of this application to any single disclosure or inventive concept if more than one is, in fact, disclosed.

The implementations illustrated herein are described in sufficient detail to enable those skilled in the art to practice the teachings disclosed. Other implementations can be used and derived therefrom, such that structural and logical substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

What is claimed is:

1. A system comprising:
a processing device; and
a memory coupled to the processing device and storing instructions that, when executed by the processing device, cause the system to perform operations comprising:
receiving one or more inputs;
processing the one or more inputs to identify one or more content presentation surfaces;
based on an identification of the one or more content presentation surfaces, modifying a first content item; and
presenting the first content item, as modified, in relation to the one or more content presentation surfaces.

2. The system of claim 1, wherein processing the one or more inputs comprises processing the one or more inputs to identify at least one location of the one or more content presentation surfaces.

3. The system of claim 1, wherein processing the one or more inputs comprises processing the one or more inputs to identify at least one position of the one or more content presentation surfaces.

4. The system of claim 1, wherein processing the one or more inputs comprises processing the one or more inputs to identify at least one shape of the one or more content presentation surfaces.

5. The system of claim 1, wherein the one or more inputs comprise one or more images.

6. The system of claim 1, wherein the memory further stores instructions for causing the system to perform operations comprising receiving, from a user device, a first communication associated with the first content item.

7. The system of claim 6, wherein the memory further stores instructions for causing the system to perform operations comprising in response to the first communication, providing a content control to the user device.

8. The system of claim 7, wherein the memory further stores instructions for causing the system to perform operations comprising receiving a second communication provided by the user device via the content control.

9. The system of claim 8, wherein the memory further stores instructions for causing the system to perform operations comprising adjusting a presentation of the first content item in response to the second communication.

10. The system of claim 1, wherein the memory further stores instructions for causing the system to perform operations comprising:
receiving an input corresponding to presentation of the first content item;
adjusting a presentation of a second content item based on the input.

11. The system of claim 1, wherein receiving one or more inputs further comprises receiving one or more inputs corresponding to a position of a content presentation device.

12. The system of claim 1, wherein receiving one or more inputs further comprises receiving one or more inputs corresponding to a position of a content presentation device in relation to the one or more content presentation surfaces.

13. The system of claim 1, wherein the memory further stores instructions for causing the system to perform operations comprising:
receiving a selection of the first content item; and
adjusting one or more aspects of the one or more content presentation surfaces based on the selection of the first content item

14. The system of claim 1, wherein the first content item is associated with one or more content presentation triggers, wherein presenting the first content item, comprises presenting the first content item in response to a determination that at least one of the one or more content presentation triggers has occurred.

15. The system of claim 1, wherein modifying the first content item comprises incorporating one or more aspects of the one or more inputs into the first content item.

16. The system of claim 1, wherein the memory further stores instructions for causing the system to perform operations comprising computing an engagement metric, wherein modifying the first content item comprises modifying the first content item based on the engagement metric.

17. The system of claim 1, wherein presenting the first content item comprises presenting the first content item in relation to a first content presentation surface and a second content item in relation to a second content presentation surface.

18. The system of claim 1, wherein presenting the first content item comprises presenting the first content item based on a content presentation schedule.

19. The system of claim 18, wherein the memory further stores instructions for causing the system to perform operations comprising:
identifying an occurrence of a content presentation trigger; and
presenting a second content item in response to identification of the occurrence of the content presentation trigger.

20. The system of claim 1, wherein the memory further stores instructions for causing the system to perform operations comprising:
identifying one or more user interactions in relation to a presentation of the first content item;
identifying a second content item that corresponds to the one or more user interactions as identified in relation to the first content item; and
presenting the second content item.

21. A method comprising:
receiving one or more inputs;
processing the one or more inputs to identify one or more content presentation surfaces;
based on an identification of the one or more content presentation surfaces, modifying a first content item;
presenting the first content item, as modified, in relation to the one or more content presentation surfaces;
receiving, from a user device, a first communication associated with the first content item;
in response to the first communication, providing a content control to the user device;
receiving a second communication provided by the user device via the content control; and
adjusting a presentation of the first content item in response to the second communication.

22. A non-transitory computer readable medium having instructions stored thereon that, when executed by a processing device, cause the processing device to perform operations comprising:
receiving one or more inputs;
processing the one or more inputs to identify one or more content presentation surfaces;
based on an identification of the one or more content presentation surfaces, modifying a first content item;
presenting the first content item, as modified, in relation to the one or more content presentation surfaces;
identifying one or more user interactions in relation to a presentation of the first content item;
identifying a second content item that corresponds to the one or more user interactions as identified in relation to the first content item; and
presenting the second content item.

23. A system comprising:
a processing device; and
a memory coupled to the processing device and storing instructions that, when executed by the processing device, cause the system to perform operations comprising:
presenting a first content item;
capturing one or more images;
processing the one or more images to identify one or more user interactions in relation to the first content item;
identifying a second content item that corresponds to the one or more user interactions as identified in relation to the first content item; and
presenting the second content item.

24. A method comprising:
projecting a first content item;
capturing one or more images;
processing the one or more images to identify one or more user interactions in relation to the first content item;
identifying a second content item that corresponds to the one or more user interactions as identified in relation to the first content item; and
projecting the second content item.
